(19) United States
(12) Patent Application Publication
(10) Pub. No.: US 2013/0211561 A1
(43) Pub. Date: Aug. 15, 2013

(54) COMPUTERIZED SYSTEM AND METHOD FOR PROVIDING REAL TIME INFORMATION REGARDING COMPETITIONS

(71) Applicants: David RABINOVITZ, Caesarea (IL); Ofer TABIB, Caesarea (IL)

(72) Inventors: David RABINOVITZ, Caesarea (IL); Ofer TABIB, Caesarea (IL)

(73) Assignee: PARALLEL TOUCH LTD., Petach-Tikva (IL)

(21) Appl. No.: 13/371,921

(22) Filed: Feb. 13, 2012

(51) Int. Cl. G06F 19/00

(52) U.S. Cl. 700/91

(57) ABSTRACT

A computerized system for providing real time information regarding competitions, the system including a user interface enabling a user to identify at least one of multiple competitions and at least one parameter of the at least one of multiple competitions in which the user has an interest and a display interface responsive to identification of at least one of the multiple competitions and the at least one parameter by the user for providing current updates of the at least one parameter.

### FIELD OF THE INVENTION

The present invention relates generally to a computerized system and method for providing real time information regarding competitions.

### BACKGROUND OF THE INVENTION

The following patent publications are believed to represent the current state of the art:
U.S. Pat. No. 6,268,849; and
U.S. Published Patent Application No.: 2001/0027475.

### SUMMARY OF THE INVENTION

The present invention seeks to provide an improved computerized system and method for providing real time information regarding competitions.

There is thus provided in accordance with a preferred embodiment of the present invention a computerized system for providing real time information regarding competitions, the system including a user interface enabling a user to identify at least one of multiple competitions and at least one parameter of the at least one of multiple competitions in which the user has an interest and a display interface, responsive to identification of the at least one of the multiple competitions and the at least one parameter by the user, for providing current updates of the at least one parameter.

In accordance with a preferred embodiment of the present invention, the display interface also provides at the request of the user at least one real time video feed of at least one of the multiple competitions identified by the user. Preferably, the at least one parameter includes a bettable outcome of at least one of the multiple competitions.

Preferably, the display interface displays to the user particulars of the multiple competitions and enables the user to select at least one of a plurality of bettable outcomes thereof which relate to the at least one parameter. Preferably, the method also includes providing an indication of odds assigned to the plurality of bettable outcomes. Preferably, the display interface includes a mobile communicator.

There is also provided in accordance with another preferred embodiment of the present invention a computerized method for providing real time information regarding competitions including the steps of identifying by a user at least one of multiple competitions and at least one parameter of the at least one of multiple competitions in which the user has an interest and responsive to the identifying of the at least one of the multiple competitions and the at least one parameter by the user, providing to the user current updates of the at least one parameter via a display interface.

In accordance with a preferred embodiment of the present invention, the method also includes providing at the request of the user, via said display interface, at least one real time video feed of at least one of the multiple competitions identified by the user. Preferably, the at least one parameter includes a bettable outcome of at least one of the multiple competitions.

Preferably, the method also includes displaying to the user, via said display interface, particulars of the identified multiple competitions and enabling the user to select at least one of a plurality of bettable outcomes thereof which relate to the at least one parameter. Preferably, the providing to the user current updates of the at least one parameter also includes providing, via the display interface, an indication of odds assigned to the plurality of bettable outcomes. Preferably, the display interface includes a mobile communicator.

There is further provided in accordance with yet another preferred embodiment of the present invention a computerized system for providing real time information regarding competitions including available bettable outcome (ABO) server functionality which stores and supplies to users information relating to at least one bettable outcome in at least one upcoming competition, betted bettable outcome (BBO) server functionality which stores information relating to bets on bettable outcomes made by a multiplicity of users and real-time bettable outcome status (RTBOS) server functionality which monitors real time status of each of the bettable outcomes and provides this status information to ones of the multiplicity of users for betted bettable outcomes of that user.

In accordance with a preferred embodiment of the present invention the system also includes a multiplicity of user interfaces communicating with the ABO server functionality, the BBO server functionality and the RTBOS server functionality. Preferably, the user interfaces include mobile communicators. Preferably, the RTBOS server functionality communicates with the BBO server functionality.

Preferably, the ABO server communicates with the BBO server functionality. Preferably, the ABO server functionality is periodically updated with the particulars of a plurality of competitions. Preferably, the ABO server functionality is periodically updated with the particulars of at least one of the bettable outcomes. Preferably, the ABO server functionality is assigned odds indicating a perceived chance of a given bettable outcome.

Preferably, the RTBOS server functionality receives at least one of real time video feeds and real time audio feeds of the competitions and makes them available on demand to the multiplicity of users. Preferably, the real time video feeds and real time audio feeds are focused on at least one of the betted bettable outcomes.

Preferably, the RTBOS server functionality is also operable for providing a real time indication as to the required changes in the betted bettable outcomes required to win a corresponding bet. Preferably, the RTBOS server functionality is also operable for providing at least one of recorded video and recorded audio feeds of the at least one competition to which the betted bettable outcomes relate. Preferably, the RTBOS server functionality is also operable for calculating the chances of each of the multiplicity of users of winning the bets based on the real time status of each of the bettable outcomes. Preferably, the BBO server functionality is also operative, upon conclusion of the competitions to which the user's betted bettable options relate, to calculate and to report to the user win/loss status of the user's betted bettable outcomes and the amount of the user's winnings or losses.

There is yet further provided in accordance with still another preferred embodiment of the present invention a computerized method for providing real time information regarding competitions including storing and supplying to users information relating to at least one bettable outcome in at least one upcoming competition, storing and supplying to users information relating to bets on bettable outcomes made by a multiplicity of users and monitoring real time status of each of the bettable outcomes and providing this status information to ones of the multiplicity of users for betted bettable outcomes of that user.

Preferably, the method also includes periodically updating the particulars of a plurality of competitions. Preferably, the method also includes periodically updating the particulars of at least one of the bettable outcomes. Preferably, the method also includes assigning odds indicating a perceived chance of a given bettable outcome. Preferably, the method also includes receiving at least one of real time video feeds and real time audio feeds of the competitions and making them available on demand to the multiplicity of users. Preferably, the real time video feeds and real time audio feeds are focused on at least one of the betted bettable outcomes.

Preferably, the method also includes providing a real time indication as to the required changes in the betted bettable outcomes required to win a corresponding bet. Preferably, the method also includes providing at least one of recorded video and recorded audio feeds of the at least one competition to which the betted bettable outcomes relate. Preferably, the method also includes calculating the chances of each of the multiplicity of users of winning the bets based on the real time status of each of the bettable outcomes. Preferably, the method also includes, upon conclusion of the competitions to which the user's betted bettable options relate, calculating and reporting to the user win/loss status of the user's betted bettable outcomes and the amount of the user's winnings or losses.

### BRIEF DESCRIPTION OF THE DRAWINGS

The present invention will be appreciated more fully from the following detailed description, taken in conjunction with the drawings in which:

FIGS. 1A, 1B, 1C and 1D are together a simplified illustration of operation of a computerized system for providing real time information constructed and operative in accordance with a preferred embodiment of the present invention;

FIGS. 2A, 2B, 2C and 2D are each a simplified illustration of a methodology for loading credits into the system of FIGS. 1A-1D;

FIGS. 3A and 3B are together a simplified illustration of methodologies for utilizing win credits from in the system of FIGS. 1A-1D;

FIGS. 4A and 4B are together a simplified illustration of a methodology for group participation in operation of the computerized system of FIGS. 1A-1D; and

FIG. 5 is a simplified functional block diagram of the functionality of FIGS. 1A-4B.

### DETAILED DESCRIPTION OF PREFERRED EMBODIMENTS

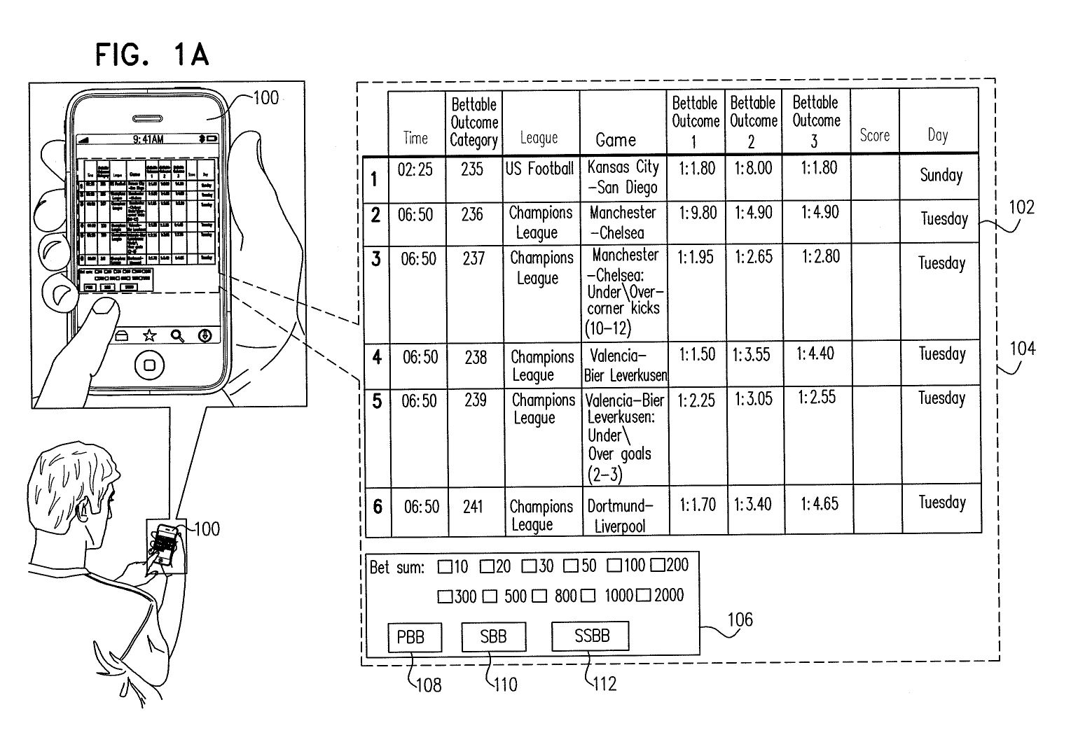

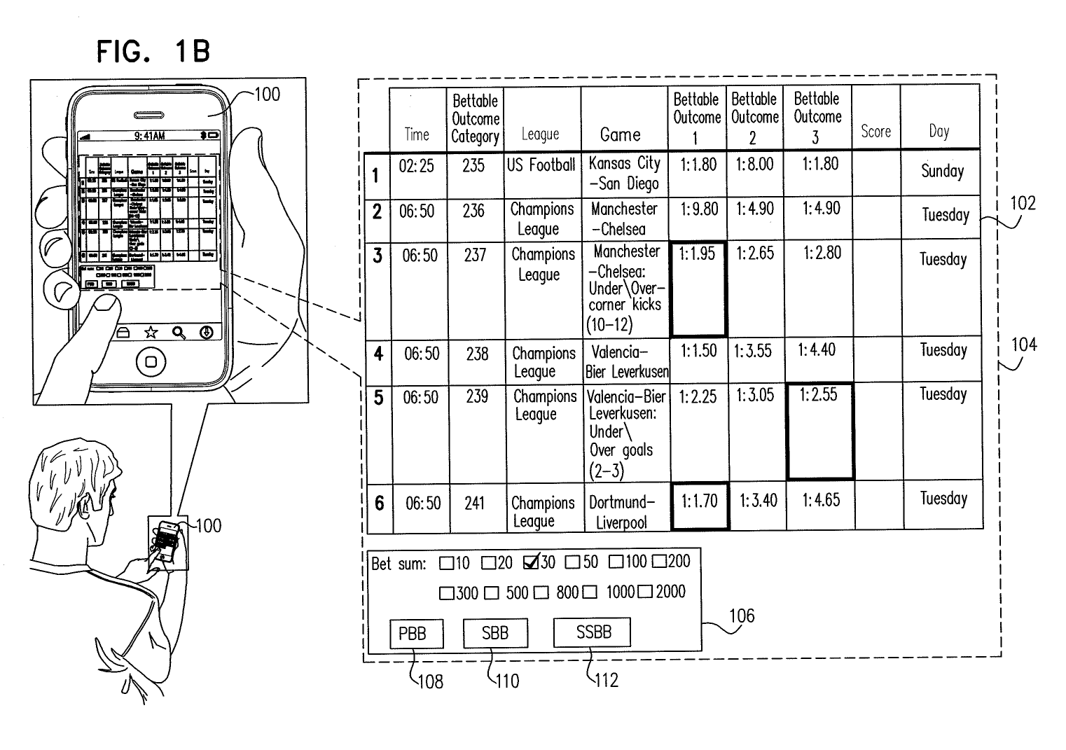

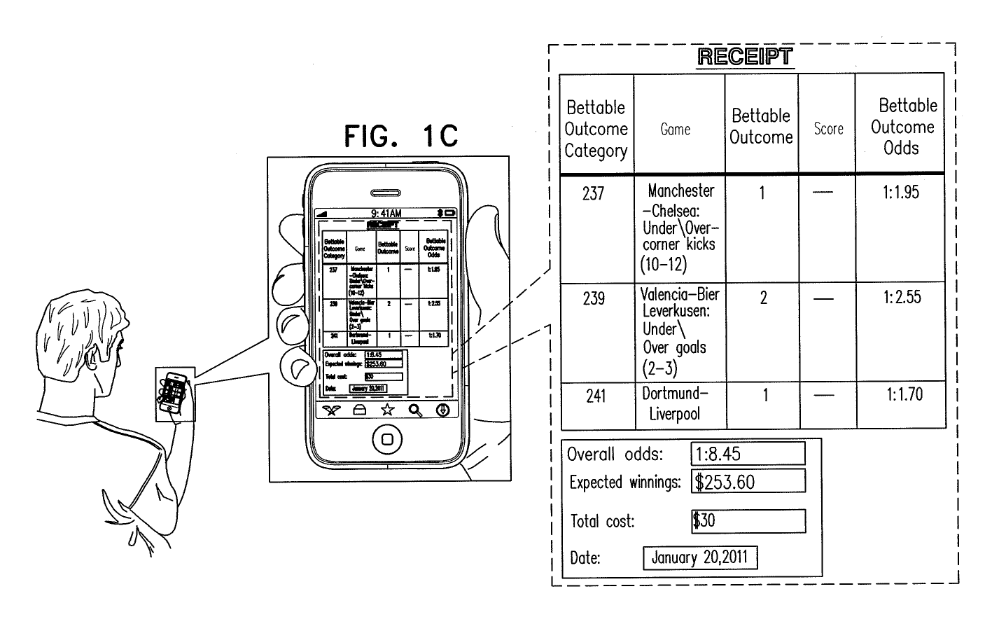

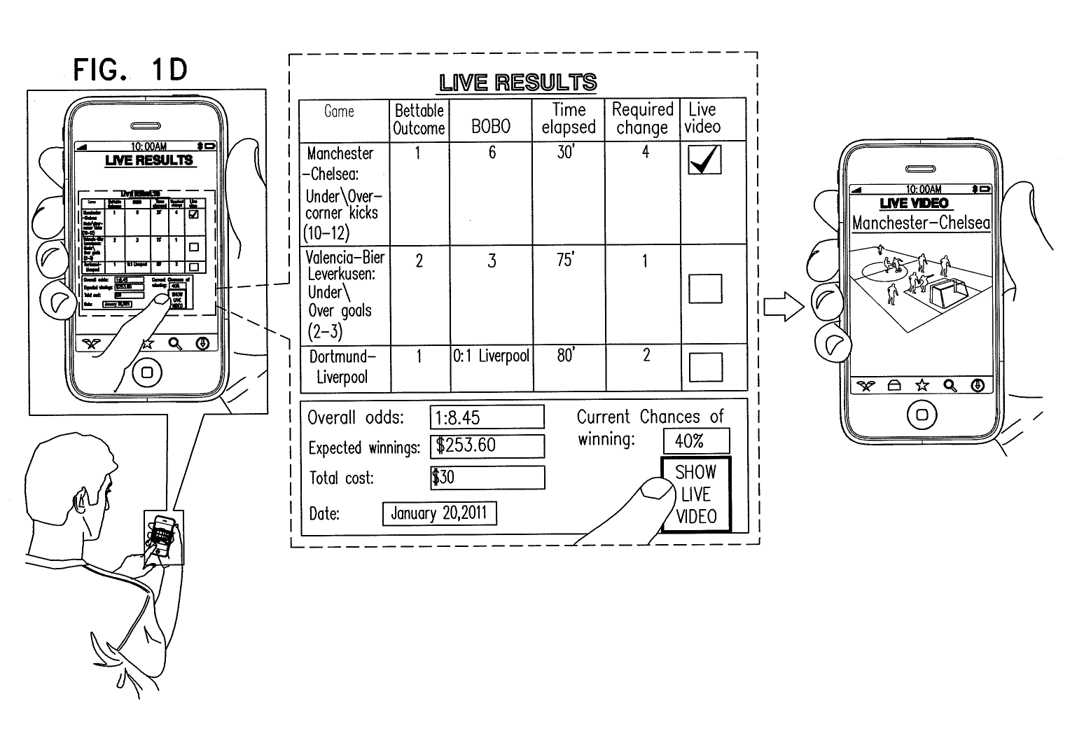

Reference is now made to FIGS. 1A, 1B, 1C and 1D, which are together a simplified illustration of operation of a computerized system for providing real time information constructed and operative in accordance with a preferred embodiment of the present invention.

Turning to FIG. 1A, a user is seen using an embodiment of the computerized system of the present invention, typically operating on an iPhone or other mobile communicator 100. As seen in FIG. 1A, the top portion 102 of the screen 104 on the iPhone 100 displays a scrollable list of competitions and of bettable outcomes of such competitions.

For example, lines 2 and 3 each represent a different bettable outcome category for the same game, a football game starting at 06:50 New York local time on Tuesday between Manchester and Chelsea in the Champions League.

Line 2 represents a bettable outcome category relating to final score, and is designated by bettable outcome category number 236. There are three bettable outcomes presented in line 2, namely Manchester Win, Tie and Chelsea Win.

Line 3 represents a bettable outcome category relating to corner kicks, and is designated by bettable outcome category number 237. There are three bettable outcomes presented in line 3, namely Under 10 Corner Kicks, Between 10 and 12 Corner Kicks and Over 12 Corner Kicks.

Odds are indicated for each of the bettable outcomes.

Typically below the scrollable list of competitions and of bettable outcomes of such competitions there is provided a form 106, typically allowing the user to select an amount of a bet, here termed the Total Bet Sum (TBS), which includes a plurality of predetermined designatable amounts. Alternatively, a user may select a bet amount.

A plurality of action buttons are preferably provided. A Place Bet Button (PBB) 108 enables the user to place a monetary bet, if such is permitted under the applicable law. A Simulate Bet Button (SBB) 110 enables the user to place a simulated bet. A Show Selected Bets Button (SSBB) 112 enables the user to display only the selected bets.

Turning now to FIG. 1B, typically, a user will select a plural number of bettable outcomes by clicking on the portions of the screen at which each bettable outcome appears, as indicated by shading in FIG. 1B. The user also preferably indicates the amount of a bet, as by clicking on the box indicating a bet of $30, as shown in FIG. 1B. The user may then click on either of the PBB button 108 or the SBB button 110, to place a monetary or a simulated bet. If the user then clicks on the SSBB button 112 a display of the user's bets appears, as shown in FIG. 1C. This display may also function as a receipt for a monetary bet.

Turning now to FIG. 1C, it is seen that the overall odds for the total bet are shown. In this case, the individual bets had odds of 1:1.95; 1:2.55 and 1:1.70 and thus the overall odds are 1/1.95×1/2.55×1/1.70=1/8.45. The display of FIG. 1C also indicates the expected winnings which are typically calculated as follows for a bet of $30.00:

$30×1.95×2.55×1.70=$253.60

Reference is now made to FIG. 1D, which illustrates a particular feature of the present invention, namely real time updates on the competitions with respect to which the user has placed bets, simulated or monetary and more specifically on the bettable outcomes with respect to which the user has placed bets, hereinafter referred to as betted-on, bettable outcomes BOBOs. Further in accordance with a preferred embodiment of the invention, a real time indication is preferably provided as to the required changes in the betted on, bettable outcomes BOBOs required for the user to win his bet.

Thus it is seen in FIG. 1D that for each bet, the elapsed time of the competition is preferably indicated together with the BOBO. Additionally in accordance with a preferred embodiment of the invention, a real time historical statistics based indication of the user's current chances of winning his bet is provided. Preferably, the real time historical statistics based indication of the user's current chances of winning is displayed alongside the original odds of winning the bet.

It is a further particular feature of the present invention that the user is presented with a clickable option to receive a live or recorded video feed of the competitions with respect to which he has placed bets.

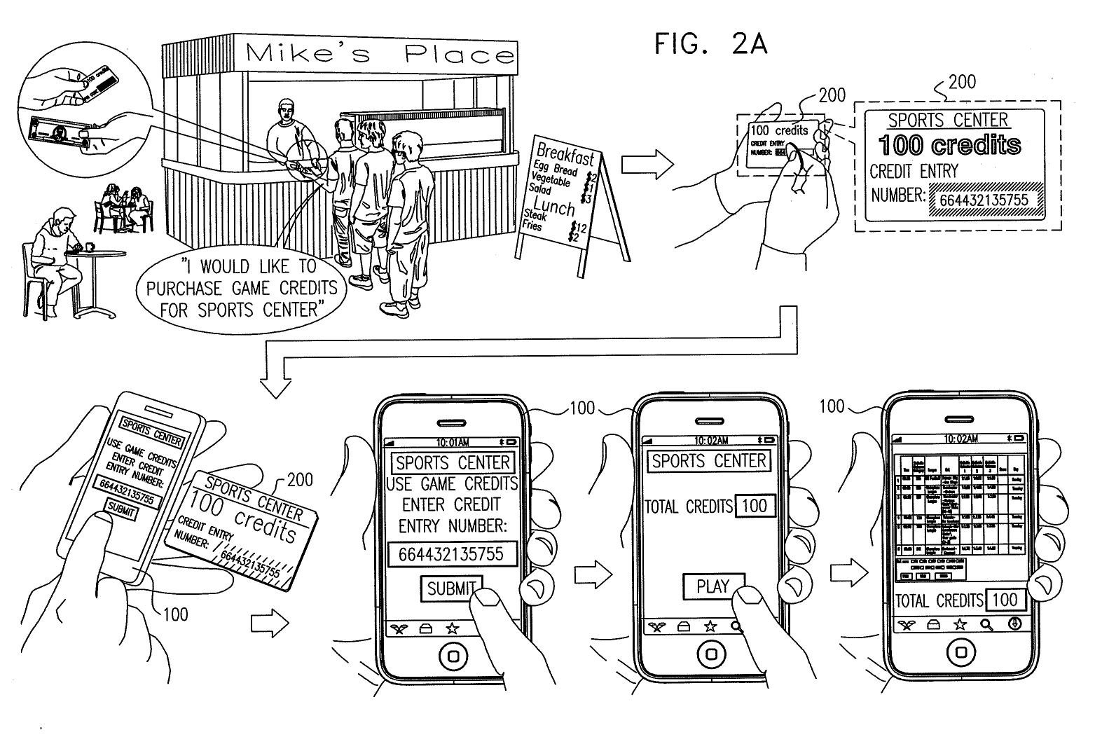

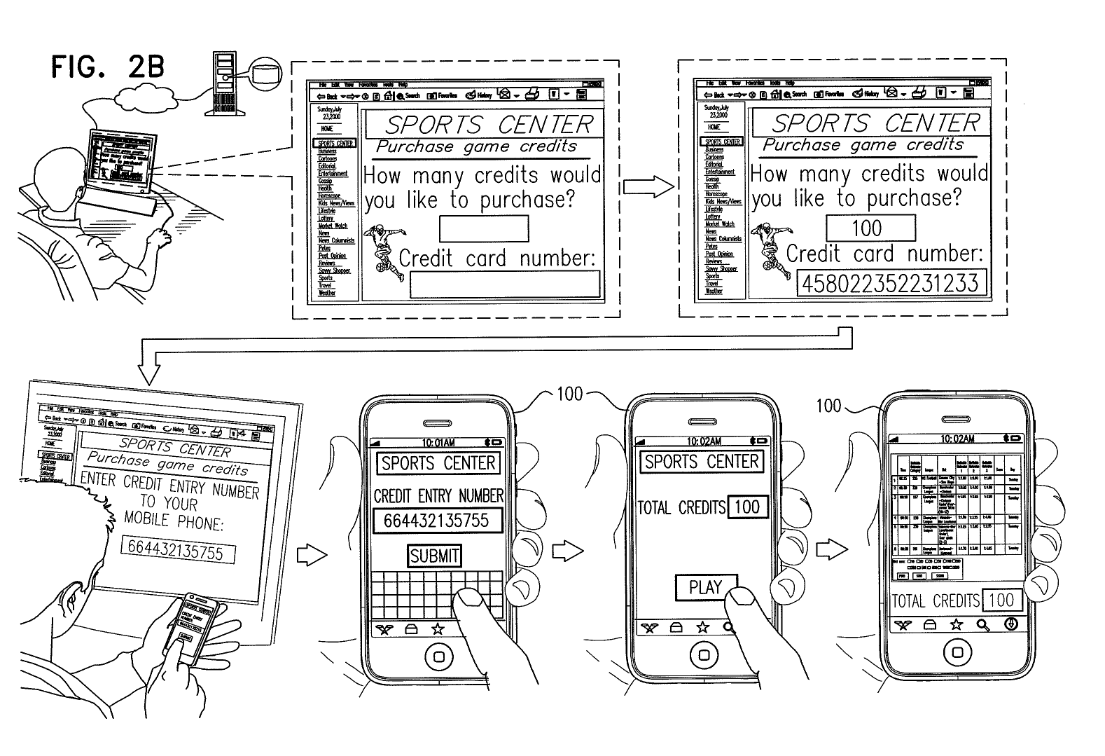

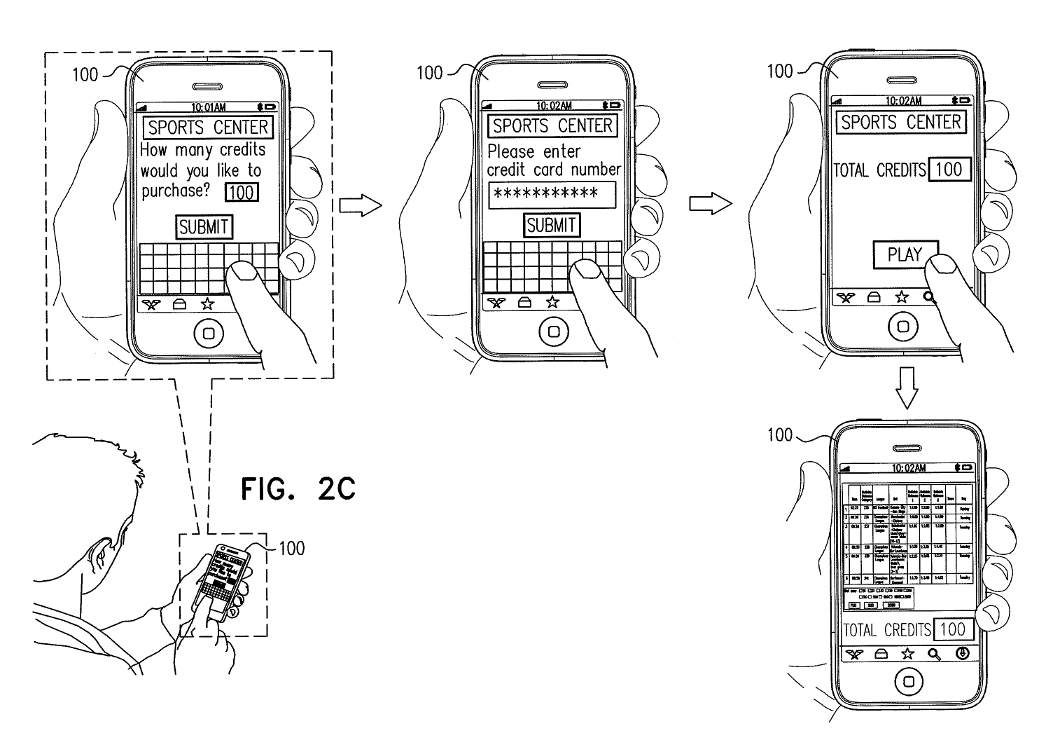

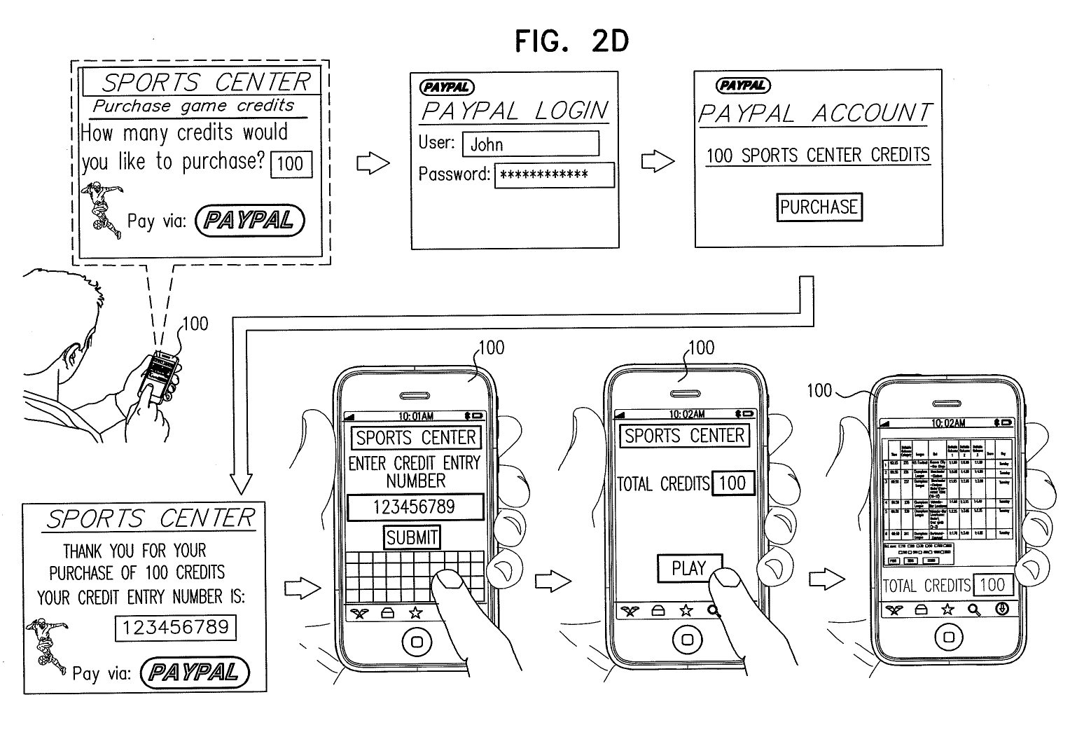

Reference is now made to FIGS. 2A, 2B, 2C and 2D, which are each a simplified illustration of a methodology for loading credits into the system of FIGS. 1A-1D.

Turning to FIG. 2A, it is seen that a user may purchase monetary or simulated game credits from a retail outlet, via a scratch card 200, which can be scratched to display a credit entry number (CEN). The user enters the CEN on his mobile communicator 100 and receives a corresponding credit, which may appear on the screen illustrated in FIG. 1A.

Turning to FIG. 2B, it is seen that a user may purchase monetary or simulated game credits from via the Internet at an e-commerce site and is given a credit entry number (CEN). The user enters the CEN on his mobile communicator 100 and receives a corresponding credit, which may appear on the screen, illustrated in FIG. 1A.

Turning to FIG. 2C, it is seen that a user may purchase monetary or simulated game credits within an application embodying the present invention, simply by entering the desired credit amount and particulars of a payment card. The user receives a corresponding credit, which may appear on the screen illustrated in FIG. 1A.

Turning to FIG. 2D, it is seen that a user may purchase monetary or simulated game credits within an application embodying the present invention via a secure payment system such as PayPal®, simply by entering the desired credit amount and particulars of a payment card and a password. The user receives a corresponding credit, which may appear on the screen illustrated in FIG. 1A.

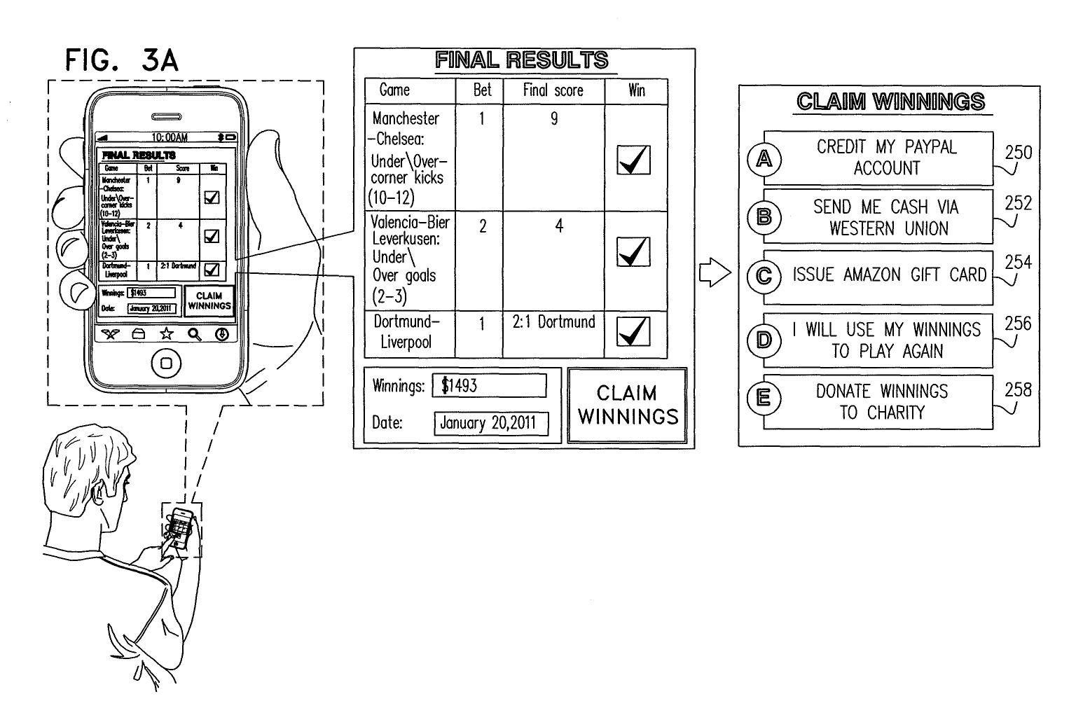

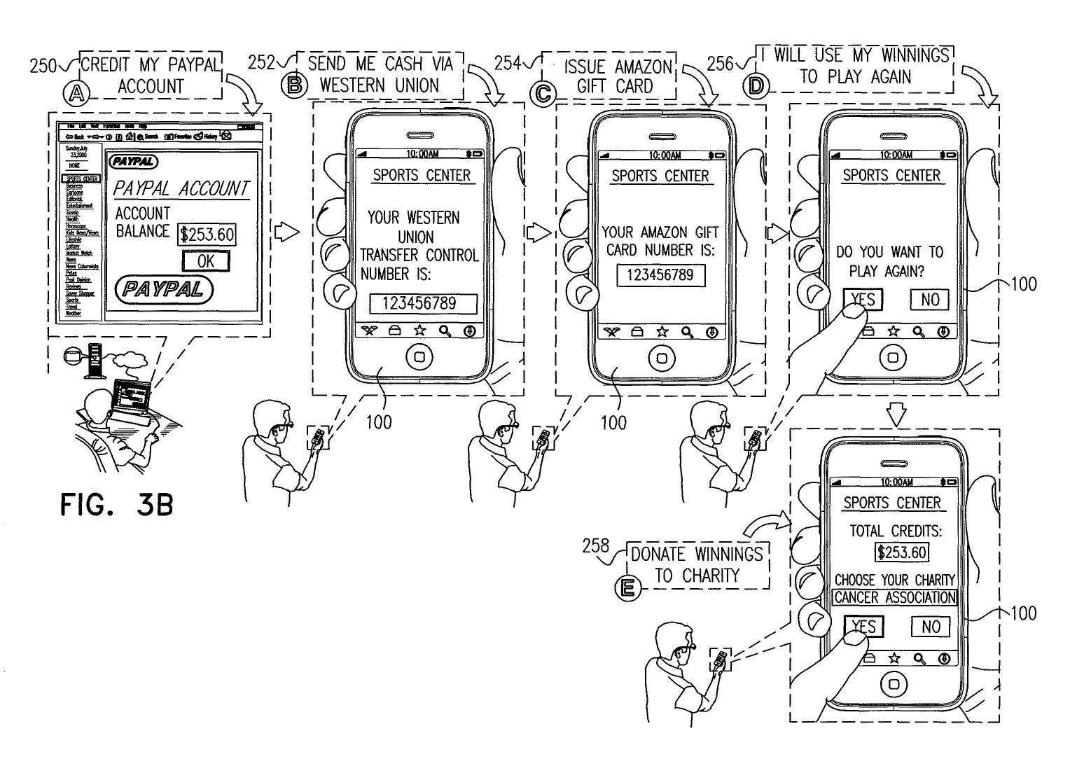

Reference is now made to FIGS. 3A and 3B, which are together a simplified illustration of methodologies for utilizing credits in the system of FIGS. 1A-1D. As seen in FIGS. 3A-3B, if a bet is won by the user, the user may claim his winnings. If the bet is a monetary bet, the user may have the option of receiving a monetary payout via a secure payment system such as PayPal® (250), a cash transfer system, such as Western Union® (252) or a selected gift card (254). Another option is to claim winnings in the form of credits which may used for future bets (256). Yet a further option is a gift to a charity which may be selected by the user in the application (258).

If the bet is simulated, the user may claim his winnings in the form of credits that may be used for future simulated bets on the system by himself or others. The credits for simulated bets may also be accumulated or counted for betting competitions between simulated betters.

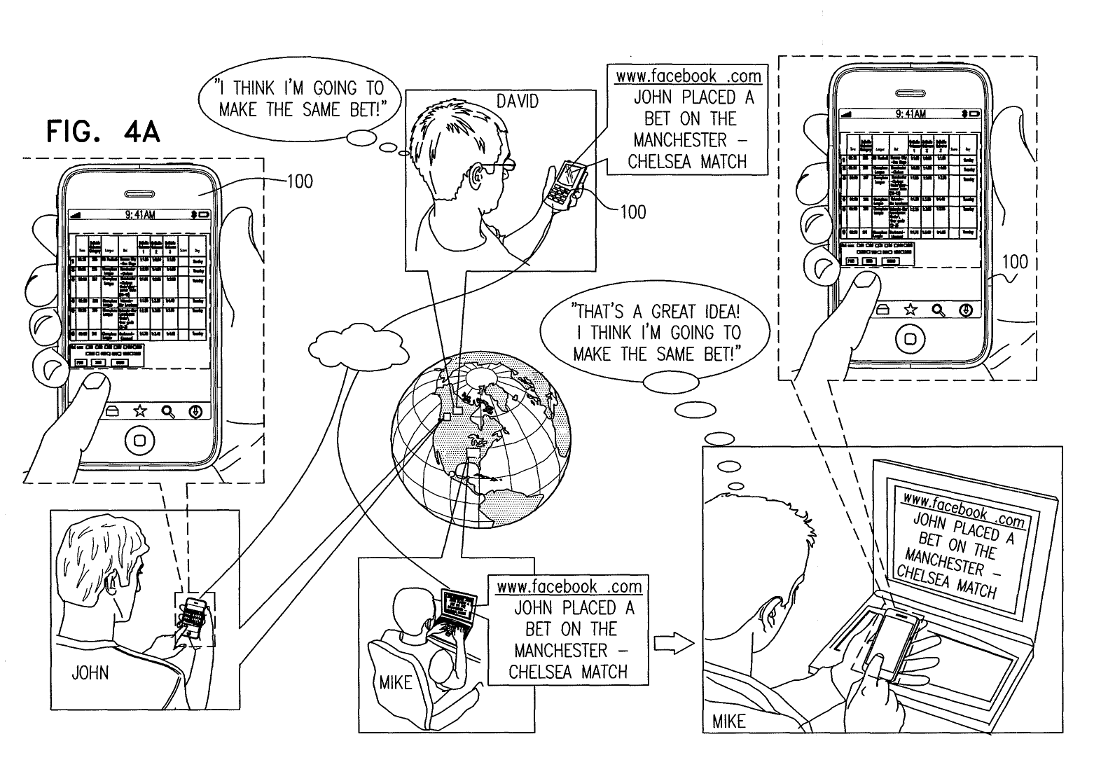

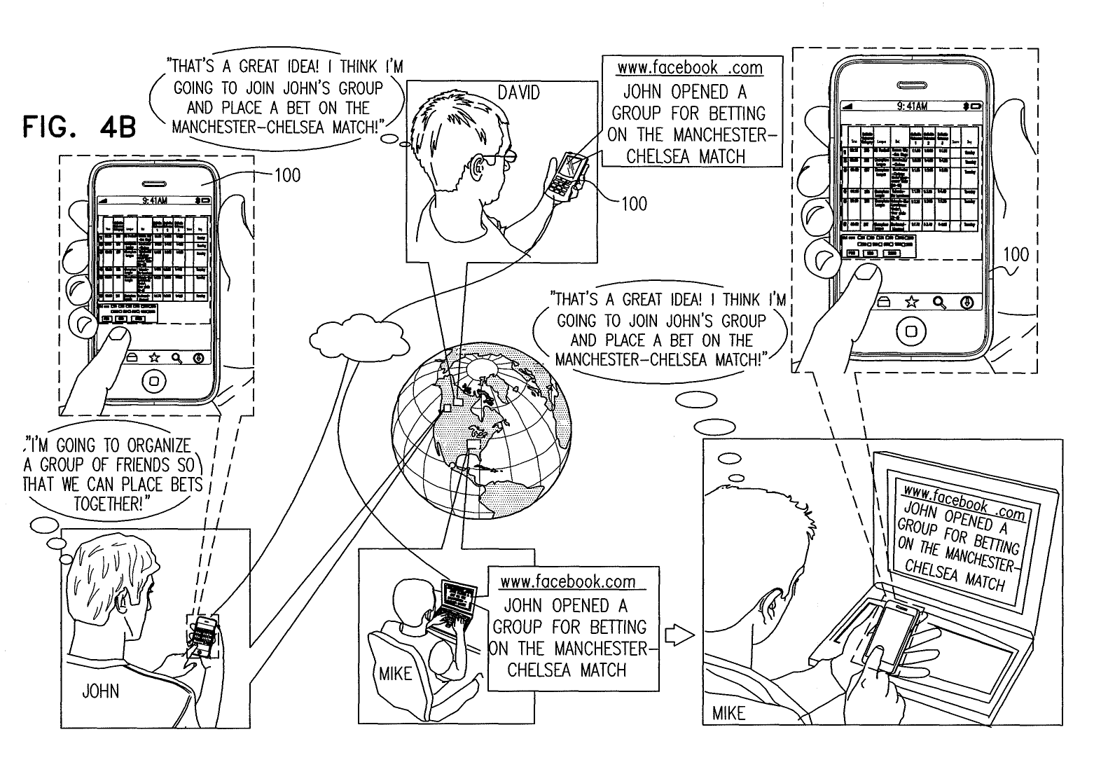

Reference is now made to FIGS. 4A and 4B which are together a simplified illustration of a methodology for group participation in operation of the computerized system of FIGS. 1A-1D. As seen in FIGS. 4A & 4B, a user may share his betting experience in real time via a social network such as FACEBOOK® or TWITTER® and thus may motivate other users to place similar bets.

In the example of FIG. 4A, John, a user on an application operative in accordance with a preferred embodiment of the present invention, employs his mobile communicator 100 to access a social network of which he is a member, such as FACEBOOK®, and to publicize his bet to at least some of his social connections who are connected to the social network. It is appreciated that access to the social network may be achieved, for example, via a link to the social network which is provided by the application.

As further shown in FIG. 4A, responsive to receiving publication of John's bet, Mike and David, who are connections of John, decide to utilize the system to place a similar bet. It is appreciated that John's social connections may be in disparate locations and may interact with the application at different times.

In the example of FIG. 4B, John employs his mobile communicator 100 to access a social network, such as FACEBOOK®, and to create therewithin a group of connections for the purpose of placing bets together and sharing the betting experience among the members of the group. The group also preferably serves as a platform for placing group bets using an application operative in accordance with a preferred embodiment of the present invention, wherein the members of the group may be in disparate locations and may interact with the application at different times.

As further shown in FIG. 4B, responsive to receiving publication of John's creation of the new group, Mike and David, who are connections of John, decide to join the group created by John.

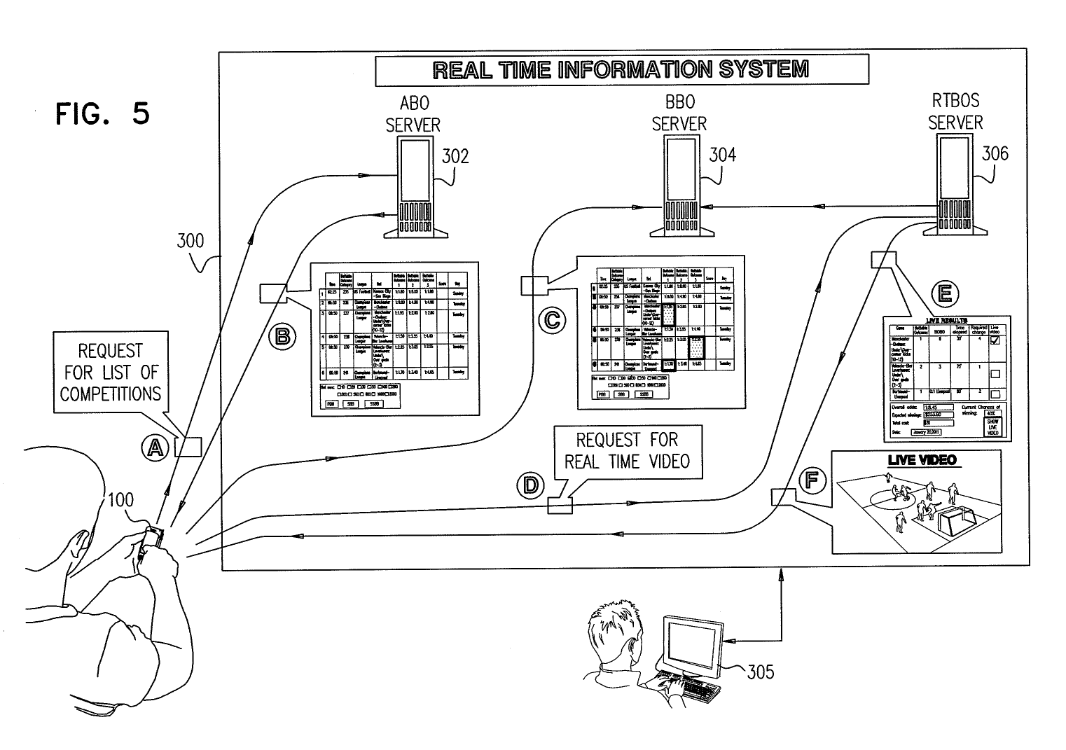

Reference is now made to FIG. 5, which is a functional block diagram of a computerized system 300 for providing real time information regarding competitions constructed and operative in accordance with a preferred embodiment of the present invention, illustrating operation of the functionality described hereinabove with reference to FIGS. 1A-1B. As seen in FIG. 5, the system 300 comprises an available bettable outcome (ABO) server 302 which stores information relating to a plurality of upcoming competitions and one or more bettable outcomes in each. ABO server 302 is preferably updated intermittently, such as on a daily basis.

A betted bettable outcome (BBO) server 304 stores information relating to bets on bettable outcomes made by a multiplicity of users, each using a mobile communicator 100 (FIGS. 1A-1D) as a user interface. Alternatively a static communicator, such as a desktop computer 305 may serve as a user interface.

A real-time bettable outcome status (RTBOS) server 306 monitors the real time status of each of the bettable outcomes and preferably provides this status information to each user interface, such as mobile communicator 100, for the betted bettable outcomes of that user and to the BBO server 304. The RTBOS server 306 preferably receives real time video feeds of the plurality of competitions and makes them available on demand to the mobile communicator 100. It is appreciated that any one or more or all of servers 302, 304 and 306 may be combined into a lesser number of servers or a single server.

In practice, the ABO server 302 is periodically updated with the particulars of a plurality of competitions, such as football games, horse races and elections. For athletic competitions, such as football games, these particulars may include one or more of the following: date, start time, league, teams and location. For each competition, the ABO server 302 is fed with one or more bettable outcomes. For example, in a football game, the bettable outcomes may be the winner, the final score, the spread of the final score, the number of penalty kicks, the number of corner kicks and the total number of goals. For example, in an election, the bettable outcomes may be the winner, the spread of votes and the total vote.

For each bettable outcome in a competition, the ABO server 302 is assigned odds indicating a perceived chance of a given outcome.

The ABO server 302 provides in response to a request from a user via the user interface, such as mobile communicator 100, information relating to one or more of the plurality of competitions. For example the user may request information relating only to football games, as in the example described hereinabove with reference to FIGS. 1A-4B. Alternatively, the user may ask to see particulars of all competitions beginning within the next two hours or may request to see particulars of all competitions for which the system provides bettable outcomes. As a further alternative, the user may ask to see particulars of all bettable outcomes of a certain type, such as corner kicks.

A typical download from the ABO server 302 is a scrollable download as described hereinabove with reference to FIG. 1A. A user, having received such a download, may, for example, be able to obtain substantial additional information regarding any of the particulars of a competition or of a bettable outcome, by clicking on such particular which preferably functions as a hyperlink.

As described hereinabove with reference to FIG. 1B, when the user makes his selections of bettable outcomes, typically by clicking on appropriate locations on the screen of his mobile communicator 100, selects a bet amount and actuates one of the PBB, SBB and SSBB buttons 108, 110 and 112, the user's selection is communicated by the mobile communicator 100 to the BBO server 304, which stores the user's selections.

It is a particular feature of the present invention that the user may request and obtain real time updates from RTBOS server 306 relating to the real time status of each of the user's betted bettable outcomes. It is a further particular feature of the present invention that the user may request and receive recorded or real time video and/or audio feeds of the competitions to which the user's betted bettable outcomes relate. The recorded or real time video and/or audio feeds may be edited or focused on the user's bettable outcomes.

It is a further particular feature of the present invention that information regarding the user's current chances of winning his bet are calculated by the RTBOS server 306 based on real time information relating to the corresponding competitions and are communicated to the user at the user's request, as described hereinabove with reference to FIG. 1D.

Upon conclusion of all of the competitions to which the user's betted bettable options relate, the BBO server 304 calculates and reports to the user via the user interface, the user's win/loss status and the amount of the user's winnings or losses in game credits and deals with any payments, monetary or otherwise.

It will be appreciated by persons skilled in the art that the present invention is not limited by what has been particularly shown and described hereinabove. Rather the scope of the present invention includes both combinations and subcombinations of various features described hereinabove and variations and modifications thereof which would occur to persons skilled in the art upon reading the foregoing, which are not in the prior art.

1. A computerized system for providing real time information regarding competitions, the system comprising:
a user interface enabling a user to identify at least one of multiple competitions and at least one parameter of said at least one of multiple competitions in which the user has an interest; and
a display interface, responsive to identification of said at least one of said multiple competitions and said at least one parameter by said user, for providing current updates of said at least one parameter.

2. A computerized system according to claim 1 and wherein said display interface also provides at the request of said user at least one real time video feed of at least one of said multiple competitions identified by said user.

3. A computerized system according to claim 1 and wherein said at least one parameter includes a bettable outcome of at least one of said multiple competitions.

4. A computerized system according to claim 1 and wherein said display interface displays to said user particulars of said multiple competitions and enables said user to select at least one of a plurality of bettable outcomes thereof which relate to said at least one parameter.

5. A computerized system according to claim 4 and wherein said display interface also provides an indication of odds assigned to said plurality of bettable outcomes.

6. A computerized system according to claim 1 and wherein said display interface comprises a mobile communicator.

7. A computerized method for providing real time information regarding competitions comprising the steps of:
identifying by a user at least one of multiple competitions and at least one parameter of said at least one of multiple competitions in which the user has an interest; and
responsive to said identifying of said at least one of said multiple competitions and said at least one parameter by said user, providing to said user current updates of said at least one parameter via a display interface.

8. A computerized method according to claim 7 and also comprising providing at the request of said user, via said display interface, at least one real time video feed of at least one of said multiple competitions identified by said user.

9. A computerized method according to claim 7 and wherein said at least one parameter includes a bettable outcome of at least one of said multiple competitions.

10. A computerized method according to claim 7 and also comprising displaying to said user, via said display interface, particulars of said identified multiple competitions and enabling said user to select at least one of a plurality of bettable outcomes thereof which relate to said at least one parameter.

11. A computerized method according to claim 10 and also comprising providing, via said display interface, an indication of odds assigned to said plurality of bettable outcomes.

12. A computerized system according to claim 7 and wherein said display interface comprises a mobile communicator.

13. A computerized system for providing real time information regarding competitions comprising:
available bettable outcome (ABO) server functionality which stores and supplies to users information relating to at least one bettable outcome in at least one upcoming competition;
betted bettable outcome (BBO) server functionality which stores information relating to bets on bettable outcomes made by a multiplicity of users; and
real-time bettable outcome status (RTBOS) server functionality which monitors real time status of each of said bettable outcomes and provides this status information to ones of said multiplicity of users for betted bettable outcomes of that user.

14. A computerized system according to claim 13 and also comprising a multiplicity of user interfaces communicating with said ABO server functionality, said BBO server functionality and said RTBOS server functionality.

15. A computerized system according to claim 14 and wherein said user interfaces comprise mobile communicators.

16. A computerized system according to claim 13 and wherein said RTBOS server functionality communicates with said BBO server functionality.

17. A computerized system according to claim 13 and wherein said ABO server communicates with said BBO server functionality.

18. A computerized system according to claim 13 and wherein said ABO server functionality is periodically updated with the particulars of a plurality of competitions.

19. A computerized system according to claim 13 and wherein said ABO server functionality is periodically updated with the particulars of at least one of said bettable outcomes.

20. A computerized system according to claim 13 and wherein said ABO server functionality is assigned odds indicating a perceived chance of a given bettable outcome.

21. A computerized system according to claim 13 and wherein said RTBOS server functionality receives at least one of real time video feeds and real time audio feeds of said competitions and makes them available on demand to said multiplicity of users.

22. A computerized system according to claim 21 and wherein said real time video feeds and real time audio feeds are focused on at least one of said betted bettable outcomes.

23. A computerized system according to claim 13 and wherein said RTBOS server functionality is also operable for providing a real time indication as to the required changes in said betted bettable outcomes required to win a corresponding bet.

24. A computerized system according to claim 13 and wherein said RTBOS server functionality is also operable for providing at least one of recorded video and recorded audio feeds of said at least one competition to which said betted bettable outcomes relate.

25. A computerized system according to claim 13 and wherein said RTBOS server functionality is also operable for calculating the chances of each of said multiplicity of users of winning said bets based on said real time status of each of said bettable outcomes.

26. A computerized system according to claim 13 and wherein said BBO server functionality is also operative, upon conclusion of said competitions to which said user's betted bettable options relate, to calculate and to report to said user win/loss status of said user's betted bettable outcomes and the amount of said user's winnings or losses.

27. A computerized method for providing real time information regarding competitions comprising:
storing and supplying to users information relating to at least one bettable outcome in at least one upcoming competition;
storing and supplying to users information relating to bets on bettable outcomes made by a multiplicity of users; and
monitoring real time status of each of said bettable outcomes and providing this status information to ones of said multiplicity of users for betted bettable outcomes of that user.

28. A computerized method according to claim 27 and also comprising periodically updating the particulars of a plurality of competitions.

29. A computerized method according to claim 27 and also comprising periodically updating the particulars of at least one of said bettable outcomes.

30. A computerized method according to claim 27 and also comprising assigning odds indicating a perceived chance of a given bettable outcome.

31. A computerized method according to claim 27 and also comprising receiving at least one of real time video feeds and real time audio feeds of said competitions and making them available on demand to said multiplicity of users.

32. A computerized method according to claim 30 and wherein said real time video feeds and real time audio feeds are focused on at least one of said betted bettable outcomes.

33. A computerized method according to claim 27 and also comprising providing a real time indication as to the required changes in said betted bettable outcomes required to win a corresponding bet.

34. A computerized method according to claim 27 and also comprising providing at least one of recorded video and recorded audio feeds of said at least one competition to which said betted bettable outcomes relate.

35. A computerized method according to claim 27 and also comprising calculating the chances of each of said multiplicity of users of winning said bets based on said real time status of each of said bettable outcomes.

36. A computerized method according to claim 27 and also comprising, upon conclusion of said competitions to which said user's betted bettable options relate, calculating and reporting to said user win/loss status of said user's betted bettable outcomes and the amount of said user's winnings or losses.
